(19) United States
(12) Patent Application Publication
(10) Pub. No.: US 2016/0332480 A1
(43) Pub. Date: Nov. 17, 2016

(54) DISPOSABLE CONTAINER FOR COATING APPLICATORS

(71) Applicant: Dustin Martin, Clarkston, MI (US)

(72) Inventor: Dustin Martin, Clarkston, MI (US)

(21) Appl. No.: 15/154,432

(22) Filed: May 13, 2016

Related U.S. Application Data
(60) Provisional application No. 62/160,820, filed on May 13, 2015.

(51) Int. Cl. B44D 3/12; A46B 17/04

(52) U.S. Cl. CPC B44D 3/125; A46B 17/04

(57) ABSTRACT

A container for a paint applicator, comprising a first layer having a top edge, opposing sidewalls, and a bottom edge; a second layer having a top edge, opposing sidewalls, and a bottom edge, the top edge is openable and sealable, the bottom edge being rupturable, and the bottom edge having a medial opening formed therein for projecting a handle of a paint applicator therethrough.

### CROSS-REFERENCE TO RELATED APPLICATION

This application is a completion application of co-pending U.S. Provisional Application Ser. No. 62/160,820, filed May 13, 2015 for “Disposable Container for Coating Applicators”, the disclosure of which is hereby incorporated by reference in its entirety including the drawings.

### BACKGROUND OF THE INVENTION

1. Field of the Invention

The present invention pertains to coating applicators, such as paint brushes and paint rollers. More particularly, the present invention pertains to containers for temporarily stowing such applicators having paint thereon. Even more particularly, the present invention concerns disposable containers for paint applicators which have paint disposed thereon.

2. Prior Art

The prior art has taught many types of packaging and/or containers for paint applicators, such as paint brushes and paint rollers, whether new or used. One of the more challenging issues with such paint applicators is the temporary stowage for later use after the applicator has been used to apply paint. Thus, stowing paint brushes and paint rollers for later use and which have already been used creates a significant stowage issue. One can clean the brush or the roller which is a messy and cumbersome job. Alternatively, one can simply throw away the applicator and start with a fresh one. Either one of these situations is not ideal.

Thus, the prior art has attempted to solve some of these issues. For example, U.S. Patent Publication No. 2005/0145518 discloses a container having a re-sealable top with an opening in the bottom for protecting a handle therethrough. The applicator is inserted through the top wherein the handle is projected through the opening in the bottom. The opening is then taped to seal off the bottom. Removal of the brush or roller from the container for subsequent re-use of the applicator involves opening the container and folding it back upon itself so that the applicator is exposed. However, such a device becomes cumbersome because one still needs to deal with the container itself.

Yet another device is shown in U.S. Pat. No. 7,111,354 where an openable container stows a paint brush or paint roller that is positionable in a first position to close off the cover and in a second position exposes the applicator. The applicator remains with the container.

Other packaging devices are shown in the prior art such as for example, U.S. Pat. Nos. 4,967,508 and 7,537,111.

It becomes apparent from the prior art that there is a need for a disposable cover, container or package which temporarily stows a paint applicator having paint thereon but which provides ready access to the applicator without the need for keeping the container in association with an applicator. It is to this to which the present invention is directed.

### SUMMARY OF THE INVENTION

In accordance with the present invention there is provided a disposable container of package or paint applicator. The applicator comprises first and second layers which cooperate to define an open interior therebetween. The layers further include means for defining a cooperable reopenable, sealable top and a partially sealed bottom.

A portion of the bottom of the first and second layers are cut out to enable an applicator handle to project therethrougth.

The sealable portion of the bottom is ruptureable by application of minimal force.

The package or container is formed from a thin film to facilitate the rupturing.

For a more complete understanding of the present invention reference is made to the following detailed description and accompanying drawing in which:

### BRIEF DESCRIPTION OF THE DRAWINGS

FIG. 1 is a plan view showing the container hereof, having a paint brush disposed therein;

FIG. 2 is a perspective view of the container with the paint brush disposed therein.

FIGS. 3 A-F is a plan view depicting the paint brush removal sequence from the container;

FIG. 4 is a perspective view of the container in conjunction with a paint roller, and

FIG. 5 is a plan view showing the deployment of a container for storing the head of the paint roller.

### DETAILED DESCRIPTION OF THE INVENTION

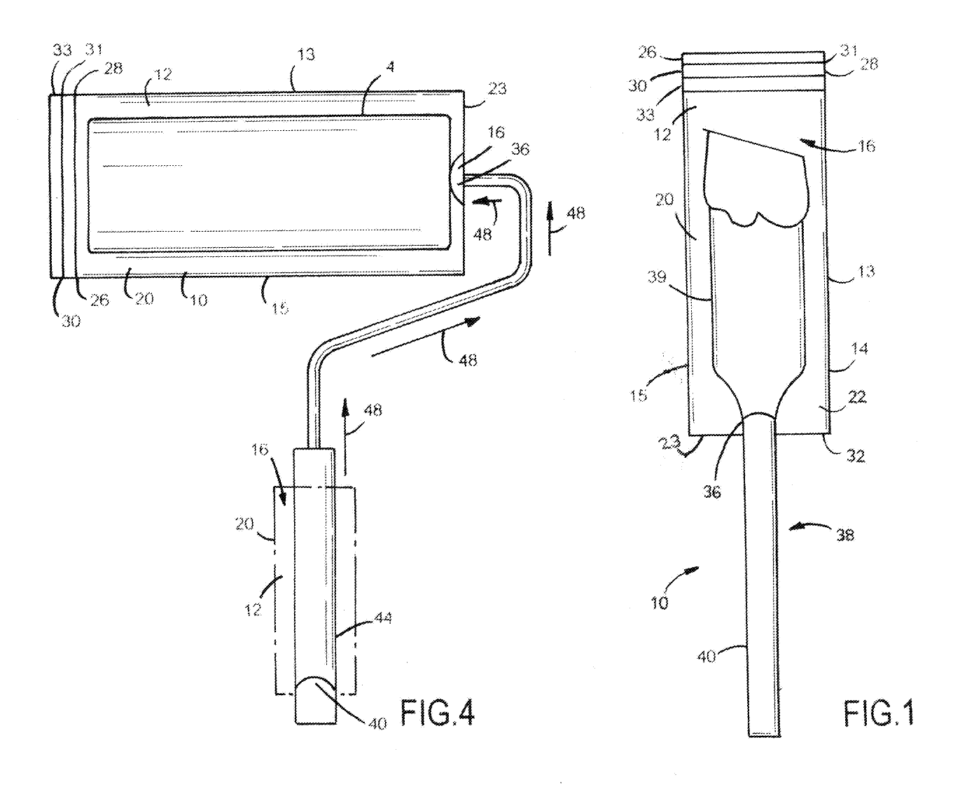

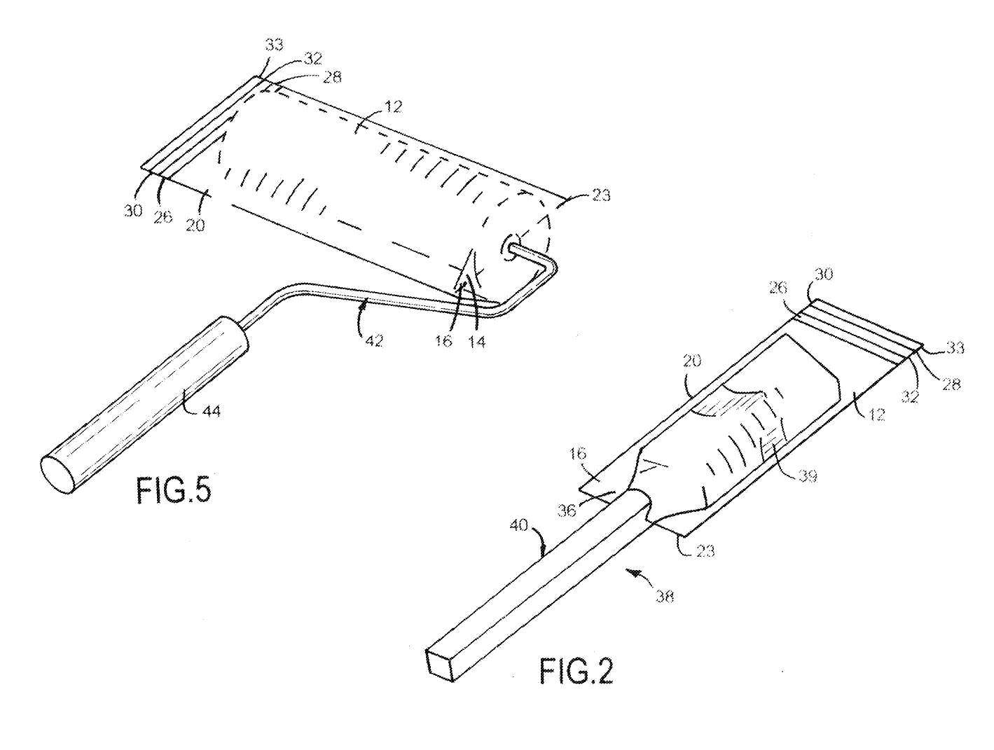

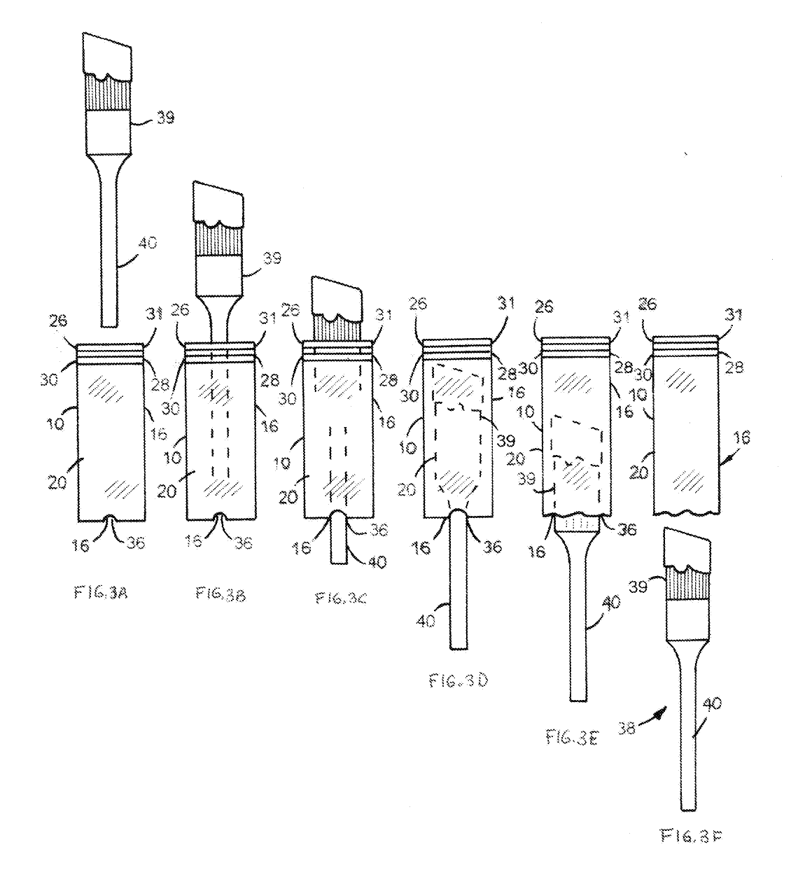

Now, and with reference to the drawing, and in particular, FIGS. 1-3, there is depicted therein a disposable container or package for a paint applicator and, generally, denoted at 10.

As shown in the drawing, the container 10 preferably comprises a thin film packaging having a first layer 12, and a second layer 14. The layers are separable and cooperate to define an open interior 16.

The first and second layers 12, 14 further cooperate to define a top portion 20 and a bottom portion 22 with sidewalls 13, 15.

The top portion 20 of the container 10 is provided with an openable and closeable seal 30 of the type which is well known and commercially available, wherein one layer has a track 31 and the other layer has an embossment 33, which sealingly fits within the track 31.

Thus, the container 10 is sealable along its top portion as at 26, 28.

The bottom edge or portion 32 of the container 10 is partially sealed as at 23 and includes a medial opening 36 through which a handle 40 of a paint brush 38 projects, as shown.

The bottom edge seal 23 is a rupturable seal which is easily burst or opened by the application of force thereto. In order to provide a rupturable container, the containers are formed from a thin film plastic such as a 2 mil or less plastic material. The opening 36 may be formed by die cutting the layers 12, 14 proximate the bottom portion 32 of the container 10.

As shown in the drawing, in use, an applicator such as the paint brush 38, having paint thereon is emplaced within the container 10 with the handle 40 projecting through the opening 36 and the brush or bristles 39 emplaced within the open interior 16 of the container 10. Once the paint brush 38 is positioned, the top portion 20 is sealed in a conventional manner by urging the embossment 33 into the track 31 with the handle 40 extending through the opening 36.

Referring now to FIGS. 4 and 5, the present invention is equally applicable to a paint roller shown at 42 and having a handle 44 in lieu of a brush.

With the handled roller 42, the container 10 is first emplaced over the handle 44 of the roller 42. Thereafter, the container 10 is translated or moved toward the roller head 46, as shown by arrows 48. As the container 10 approaches the roller head 46, it is opened, slid thereover, and then sealed.

To re-use the applicator 42, the top portion 20 of the container 10 is grasped and the handle 44 of the applicator 42, either the brush or roller, is pulled toward the rupturable bottom seam 23. Because of its weakness, the bottom seam 23 readily ruptures and bursts thereby enabling the applicator 42 to be re-used.

Thereafter, the container 10, itself, having residual paint therewithin is easily disposed of or discarded.

Thus, the present invention provides an easier and cleaner mode of use and storage of a “wet” paint brush or roller.

Having, thus, described the invention, what is claimed is:

1. A container for storing a wet paint applicator, comprising:
(a) a first layer having a top edge, opposing sidewalls, and a bottom edge;
(b) a second layer having a top edge, opposing sidewalls, and a bottom edge; and
wherein the top edges are openable and sealable together, the respective opposing sidewalls of the first and second layers are sealed together, the bottom edges are partially sealed together and include a medial portion formed therein for receiving a handle of a paint applicator therethrough,

2. The applicator of claim 1 wherein each of the films is formed from a thin film, the bottom edge being a ruptureable seat

3. The applicator of claim 2 wherein the thin film has a thickness of less than about 2 mm.

4. The applicator of claim 3 wherein:
(a) the top edge of one layer has a track formed therein, the top edge of the other layer has an embossment formed thereon, the embossment being fitable in the track to seal the top portion of the container; and
(b) the rupturable seal extending from the medial opening to respective sidewalls.
